(19) United States
(12) Patent Application Publication
(10) Pub. No.: US 2016/0229461 A1
(43) Pub. Date: Aug. 11, 2016

(54) Improvements to a Mudflap Bracket Assembly

(71) Applicant: Brian WASOWICZ, New Lenox, IL (US)

(72) Inventor: Brian Wasowicz, New Lenox, IL (US)

(21) Appl. No.: 15/024,326

(22) PCT Filed: Sep. 24, 2014
(86) PCT No.: PCT/US2014/057180

§ 371 Date: Mar. 24, 2016

Related U.S. Application Data
(60) Provisional application No. 61/881,637, filed on Sep. 24, 2013.

(51) Int. Cl. B62D 25/18; B62D 65/16

(52) U.S. Cl. CPC B62D 25/186; B62D 65/16

(57) ABSTRACT

This invention relates to a mudflap bracket. Namely, this invention relates to an improvement in the mudflap bracket having an arrangement that improves clearance against a truck or trailer frame rail and prevents the bracket or mudflap from catching on the truck or trailer frame rail and angling into the frame rail. This invention alters the arrangement of the typical mudflap bracket so that the bracket attaches in a bottom up.

### CROSS-REFERENCE TO RELATED APPLICATIONS

This application is related to and claims priority from earlier filed U.S. Provisional Application No. 61/881,637 entitled Improvements to a Mudflap Bracket Assembly filed on Sep. 24, 2013.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LIST COMPACT DISC APPENDIX

Not applicable.

### BACKGROUND OF THE INVENTION

Mudflaps and their accompanying brackets are widely known in prior art as necessary accessories for trucks, tractors, trailers, and other similar vehicles. Laws and industry regulations require that certain vehicles, such as a trailer or tractor, be outfitted with mudflaps to prevent damage or injury to other vehicles and their inhabitants on the road. Mudflaps attach and extend from the side of the frame rail of a truck or trailer behind the rearmost axle, behind the tires, to prevent objects, such as rocks, mud, and other road debris, from flying into the air by the rotating action of the wheels. Mudflaps are typically made from a flexible material, like rubber, that is durable enough to withstand the abuse it may receive from flying debris and the elements. Typically, mudflaps are attached to the underside of a truck tractor or trailer by a bracket attachment to the trailer frame. This bracket attachment usually hangs from the truck or trailer frame in the “top down” position. This means that the bracket attachment hooks onto the side of the frame at the top side of the frame rail and extends out past the wheel and hangs down over the wheel. The mudflap is then attached to this extended part of the bracket and serves as a guard for the wheel. The problem with this usual type of bracket attachment is that it tends to catch on the frame if the mudflap unintentionally gets trapped between the wheel and some other obstruction, like debris or even a curb while the vehicle is operating in reverse. The trapped mudflap pulls and stresses the bracket causing it to become loose and turn while attached to the frame. This can cause the mudflap to tear off while in use which exposes the wheel, creates a dangerous situation, and causes a driver to be in violation of the law. This situation could also cause damage to the frame of the trailer which could create a dangerous operating situation as well as a possible costly repair for a user.

Furthermore, this typical “top down” assembly causes the entire bracket assembly to bend inward when the flap either becomes heavy, due to debris affixed thereto, or as a result of the vehicle being driven over an uneven surface such as a bumpy or damaged roadway. The force and stress placed on the bracket as a result of the inward bend eventually causes the bracket to snap off of the frame rail.

Other solutions to this problem have been in the form of a mudflap bracket attachment that utilizes coiled springs or spring loaded brackets to give the brackets more leeway and shock absorption. While these solutions do give the bracket some more flexibility, these brackets are still assembled in the top down position which can still cause the same problems as discussed above.

### BRIEF SUMMARY OF THE INVENTION

This invention relates to a mudflap bracket assembly having an improved arrangement to prevent damage to a truck tractor or trailer frame rail, as well as to the bracket itself, by eliminating instances where the mudflap and its attachment bracket becomes pulled and stressed. Specifically, this invention relates to a mudflap bracket assembly for the mounting to the side of a truck tractor or trailer frame rail comprising a rigid frame having a frame rail attachment point at one end and a mudflap attachment point at the other end and a mounting bracket located on the frame rail for receiving said frame from the bottom of the mounting bracket. The mudflap bracket assembly further comprises a mudflap attached to the frame at the mudflap attachment point. Further, within this invention the frame rail attachment point attaches to the frame rail at the bottom side of the rail in a “bottom up” position. In this arrangement, the mounting bracket receives the rigid frame from the bottom of the mounting bracket which is a significant improvement over existing prior art as the bracket will no longer catch on the frame if the mudflap is stressed and pulls at the bracket. This arrangement gives the bracket assembly more clearance with respect to the truck, tractor or trailer frame rail. Furthermore, this arrangement will eliminate the risk of the bracket assembly bending inward as a result of debris attaching to the mudflap or the vehicle being operated over a rough surface.

One skilled in the art will recognize that the mounting bracket is preferred to be made of a rigid material, such as a metal, durable enough to withstand the conditions of a road. However, it is anticipated that any suitable material may be used. This mounting bracket will attach to a frame rail by at least one fastening means. Such at least one fastening means will comprise a bolt, screw, pin or other similar fastener. Preferably the mounting bracket will be mounted to the frame rail by a first and second fastening means.

Once the rigid frame is received into the mounting bracket, a third fastening means holds the rigid frame into place. Prior art arrangements, i.e. where the frame is received from the top of the mounting bracket, rely on gravity along with a possible cotter pin to hold the rigid frame in place within the bracket. Adding a third fastening means through the mounting bracket and into the frame provides this invention with the support needed to maintain its position within the assembly.

One preferred embodiment of this invention is the coiled arrangement. This arrangement utilizes a rigid frame in the shape of a coil immediately after the truck tractor or trailer frame rail attachment point. The coil shape serves to provide some flexibility to the rigid frame but also gives the rigid frame. It is common in rigid frames to see a two or three coil arrangement; however, for purposes of this invention, two coils are anticipated. One skilled in the art will recognize that less than two or more than two coils are equally anticipated.

Another preferred embodiment of this invention is the straight rigid frame arrangement. This arrangement does not utilize any coils and simply angles downward or extends straight out from the frame rail attachment point over the wheel.

One skilled in the art will recognize that any straight, coiled or angled arrangement of the rigid frame may be anticipated.

A mudflap attaches to the rigid frame at the mudflap attachment point by conspicuity tape. This invention may either be outfitted on a newly manufactured truck tractor or trailer or retro-fitted to existing trucks, tractors or trailers. It is also modular in nature and is customizable to fit any truck or trailer or vehicle where mudflaps are desired.

It will be appreciated by those skilled in the art that many modifications and variations may be made to the methods of the invention described herein without departing from the spirit and scope of the invention.

### BRIEF DESCRIPTION OF THE SEVERAL VIEWS OF THE DRAWINGS

Possible and preferred features of the present invention will now be described with particular reference to the accompanying drawings. However, it is to be understood that the features illustrated in and described with reference to the drawings are not to be construed as limiting on the broad scope of the invention. In the drawings:

FIG. 1 depicts the prior art arrangement of a mudflap bracket in the top down position.

FIG. 2 is a prior art view of the prior art mounting bracket attaching to the truck or trailer frame as it would be in a top down arrangement.

FIG. 3 depicts the prior art mudflap in a position where it has started to bend inward and is in the dangerous position of possibly breaking away from the underside of the truck or trailer frame.

FIG. 4 is a view of the prior art wherein the bracket is breaking away from the truck or trailer as the frame in a top down arrangement presses against the frame rail.

FIG. 5 depicts the prior art with a straight rigid frame in the top down position.

FIG. 6 depicts the prior art straight rigid frame breaking away from the truck or trailer frame as a result of the top down arrangement as the rigid frame presses against the frame rail.

FIG. 7 depicts the mudflap bracket assembly in the bottom up arrangement wherein the rigid frame is received up through the bottom of the mounting bracket.

FIG. 8 is exploded top perspective view of the rigid frame as it is received in the mounting bracket from the bottom up position.

### DETAILED DESCRIPTION OF THE INVENTION

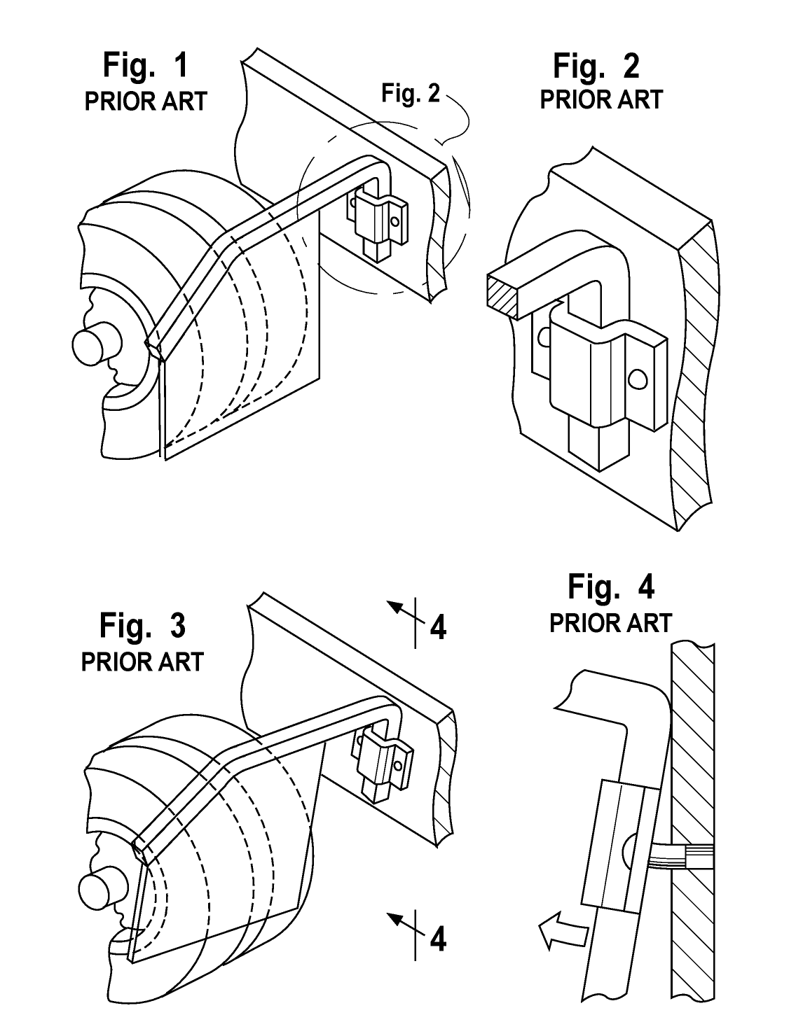

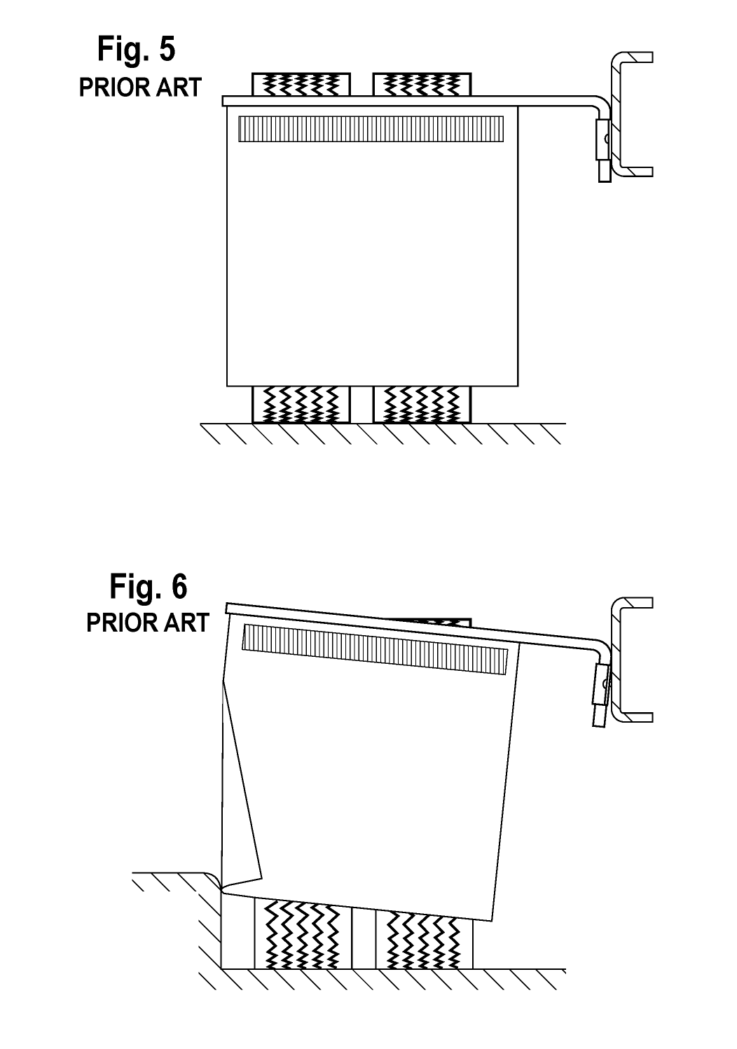

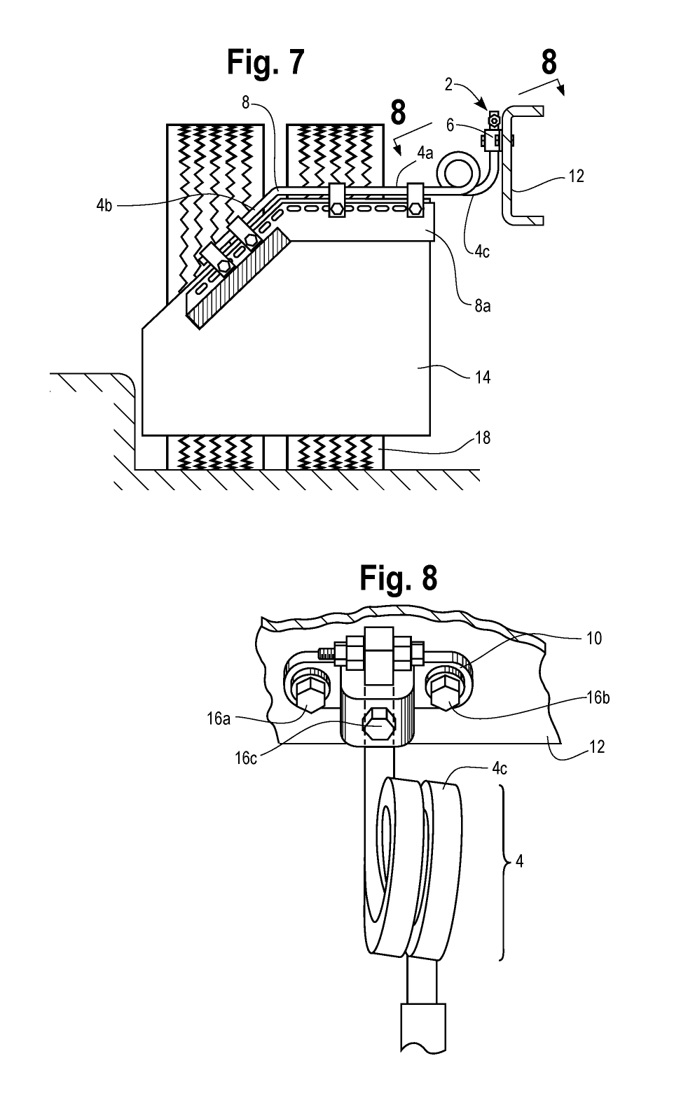

Turning to the Figures, FIGS. 7 and 8 depict the preferred arrangements of this invention. The mudflap bracket assembly 2 comprises a rigid frame 4 a frame rail attachment point 6 at one end and a mudflap attachment point 8 at the other end; a mounting bracket 10 located on the frame rail for receiving said frame from the bottom of the mounting bracket; and a mudflap 14 attached to the frame at the mudflap attachment point 8. The rigid frame 4 affixes to the frame rail 12 in a bottom up arrangement that is a significant improvement over the top down arrangement in the prior art depicted in FIGS. 1-6. The rigid frame is held into place against the frame rail by way of a mounting bracket 10 and fastened securely to the frame rail by at least one bolt 16. The first bolt 16a and second bolt 16b hold the mounting bracket 10 against the frame rail in a secure position so that the mounting bracket is unable to move from that position.

The rigid frame rail 4 is inserted into the mounting bracket 10 from the bottom position as seen in FIGS. 7 and 8. A third bolt 16c is driven though the mounting bracket 10 and into rigid frame 4 through the frame rail attachment point 6 to hold the rigid frame in this position.

Immediately after the frame rail attachment point 6 the rigid frame extends outward from the trailer or truck frame to cover the wheels 18 with the mudflap 14 hanging therefrom. In FIGS. 7 and 8, the rigid frame 4 extends into a coiled portion 4c before extending into a first straight portion 4a, and then angling into a second straight portion 4c. While this preferred embodiment depicts a coiled portion 4c, one skilled in the art will recognize that the rigid frame may be free from coils or comprise more coiled portions than shown.

The mudflap 14 attaches to rigid frame 4 at a location along the first and second straight portion 4a, 4b by way of a mudflap attachment point 8. In most circumstances, conspicuity tape 8a would serve to provide the mudflap attachment point 8.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

1. A mudflap bracket assembly for mounting to a frame rail of a truck, tractor, or trailer, the mudflap bracket assembly comprising:
a rigid frame having a frame rail attachment point at one end and at least one mudflap attachment point at the other end; and
a mounting bracket configured to (a) attach to the frame rail and (b) receive said rigid frame from the bottom of the mounting bracket.

2. The mudflap bracket assembly as in claim 1, wherein a mudflap is attached to the rigid frame at the at least one mudflap attachment point.

3. The mudflap bracket assembly as in claim 2, wherein the at least one mudflap attachment point comprises multiple mudflap attachments points.

4. The mudflap bracket assembly as in claim wherein a mudflap attaches to the at least one mudflap attachment point on the rigid frame by conspicuity tape.

5. The mudflap bracket assembly as in claim 1, wherein said mounting bracket attaches to the frame rail by at least one fastening means.

6. The mudflap bracket assembly as in claim 5, wherein the at least one fastening means comprises a first and a second fastening means.

7. The mudflap bracket assembly as in claim 6, wherein the rigid frame is received in the mounting bracket and secured by a third fastening means.

8. The mudflap bracket assembly as in claim 1, wherein the mudflap bracket assembly is modular and retro-fittable.

9. The mudflap bracket assembly as in claim 1, wherein the rigid frame is straight, coiled, or angled to extend away from the frame rail and into a position for covering a wheel of the truck, tractor or trailer.

10. A method of attaching a mudflap to a frame rail of a truck, tractor, or trailer via a mounting bracket and a rigid frame having a frame rail attachment point at one end and at least one mudflap attachment point at the other end, the method comprising:
attaching the mounting bracket to the frame rail;
inserting, into the bottom of a mounting bracket, the frame rail attachment point of the rigid frame; and
attaching least one mudflap to the at least one mudflap attachment point of the rigid frame.

11. The method of claim 10, wherein the at least one mudflap attachment point comprises multiple mudflap attachment points.

12. The method of claim 10, wherein attaching the least one mudflap to the at least one mudflap attachment point of the rigid frame comprises:
attaching the at least one mudflap to the at least one mudflap attachment point of the rigid frame by conspicuity tape.

13. The method of claim 10, further comprising:
attaching the mounting bracket to the frame rail by at least one fastening means.

14. The method of claim 13, wherein the at least one fastening means comprises a first and a second fastening means.

15. The method of claim 14, further comprising:
securing the rigid frame into the mounting bracket by a third fastening means.

16. The method of claim 10, wherein the rigid frame is straight, coiled, or angled to extend away from the frame rail.
